(19) United States
(12) Patent Application Publication
(10) Pub. No.: US 2021/0373159 A1
(43) Pub. Date: Dec. 2, 2021

(54) ToF DISTANCE SENSOR AND ELECTRONIC DEVICE

(71) Applicant: Sharp Fukuyama Semiconductor Co., Ltd., Fukuyama City (JP)

(72) Inventors: Norikazu OKADA, Fukuyama City (JP); KOUJI IWAMORI, Fukuyama City (JP); TOSHIYUKI TAKADA, Fukuyama City (JP)

(21) Appl. No.: 17/334,319

(22) Filed: May 28, 2021

(30) Foreign Application Priority Data
Jun. 1, 2020 (JP) 2020-095305

(51) Int. Cl. G01S 17/42; G01S 7/484; G01S 7/4865; H01S 5/183

(52) U.S. Cl. CPC G01S 17/42; H01S 5/183; G01S 7/4865; G01S 7/484

(57) ABSTRACT

A ToF distance sensor comprises a light-emitting element configured to emit pulsed light; a first light collector configured to collect the pulsed light emitted from the light-emitting element; a light-receiving element; and a cover provided with a first region configured to output the pulsed light collected by the first light collector to an outside, and a second region configured to cause the pulsed light reflected by a target measurement object to be incident toward the light-receiving element, wherein the first region is a scattering region configured to scatter the pulsed light.

### CROSS-REFERENCE TO RELATED APPLICATION

The present application claims priority from Japanese Application JP2020-095305, the content of which is hereby incorporated by reference into this application.

### BACKGROUND

### 1. Field

An aspect of the disclosure relates to a Time of Flight (ToF) distance sensor configured to measure distance by using ToF, and an electronic device equipped with the same.

As a ToF distance sensor configured to detect a liquid surface and an electronic device equipped with the same, an air conditioner has been proposed (see WO 2020/032111). This ToF distance sensor is a sensor whose cover includes a transmissive region that covers a light-emitting unit and a scattering region that covers a measurement light receiving unit.

### SUMMARY

It has been found that when it is attempted to apply the known technique disclosed in WO 2020/032111 to a water purifier, for example, the following problem occurs, and this problem is yet to be solved. In a water purifier, a liquid may additionally and forcefully be poured into a water storage container. When the liquid is forcefully poured and the liquid surface of a target measurement object fluctuates, it may not be possible to accurately and stably detect transition of the liquid when measuring distance.

An aspect of the disclosure has been conceived in view of the above-mentioned problem, and an object thereof is to provide a ToF distance sensor able to accurately and stably detect, even when the liquid surface of a target measurement object fluctuates, transition of the liquid, and provide an electronic device equipped with the ToF distance sensor.

In order to solve the above problem, a ToF distance sensor according to an aspect of the disclosure includes a light-emitting element configured to emit pulsed light; a first light collector configured to collect the pulsed light emitted from the light-emitting element; a light-receiving element; and a cover provided with a first region configured to output the pulsed light collected by the first light collector to an outside, and a second region configured to cause the pulsed light reflected by a target measurement object to be incident toward the light-receiving element, wherein the first region is configured to be a scattering region that scatters the pulsed light.

In order to solve the above problem, a ToF distance sensor according to another aspect of the disclosure includes a light-emitting element configured to emit pulsed light; a light-receiving element; a cover provided with a first region configured to output the pulsed light emitted from the light-emitting element to an outside, and a second region configured to cause the pulsed light reflected by a target measurement object to be incident toward the light-receiving element; and a second light collector configured to collect the pulsed light that is incident toward the light-receiving element, wherein the second region is configured to be a scattering region that scatters the pulsed light.

According to an aspect of the disclosure, an effect is exhibited in which, even when the liquid surface of a target measurement object fluctuates, transition of the liquid can be accurately and stably detected.

### BRIEF DESCRIPTION OF THE DRAWINGS

FIG. 1 is an explanatory diagram illustrating an example of a water purifier of a first embodiment.

FIG. 2 is a perspective view illustrating a ToF distance sensor in the first embodiment.

FIG. 3 is a perspective view illustrating an external shape in a state where a cover is removed from the ToF distance sensor in FIG. 2.

FIG. 4 is a cross-sectional view taken along the line A-A in FIG. 2.

FIG. 5 is an explanatory cross-sectional view schematically illustrating pulsed light emitted from a light-emitting element and pulsed light incident toward a light-receiving element.

FIG. 6 is a graph showing a measurement time and a distance fluctuation of output of a ToF distance sensor when water is poured into the water purifier of the first embodiment.

FIG. 7 is an explanatory cross-sectional view schematically illustrating a ToF distance sensor of a second embodiment and pulsed light emitted from a light-emitting element.

FIG. 8 is a perspective view illustrating a cover of a ToF distance sensor of a third embodiment.

FIG. 9 is an explanatory cross-sectional view schematically illustrating a ToF distance sensor adopting a modified example of the cover in FIG. 8, and pulsed light emitted from a light-emitting element.

FIG. 10 is an explanatory cross-sectional view schematically illustrating the ToF distance sensor of the third embodiment and pulsed light emitted from a light-emitting element.

FIG. 11 is an explanatory cross-sectional view schematically illustrating a ToF distance sensor of a fifth embodiment and pulsed light emitted from a light-emitting element.

FIG. 12 is a cross-sectional view illustrating a ToF distance sensor of a sixth embodiment.

### DESCRIPTION OF EMBODIMENTS

Hereinafter, embodiments for implementing an aspect of the disclosure will be described in detail with reference to the drawings. Note that an aspect of the disclosure is not limited to the following embodiments.

### First Embodiment

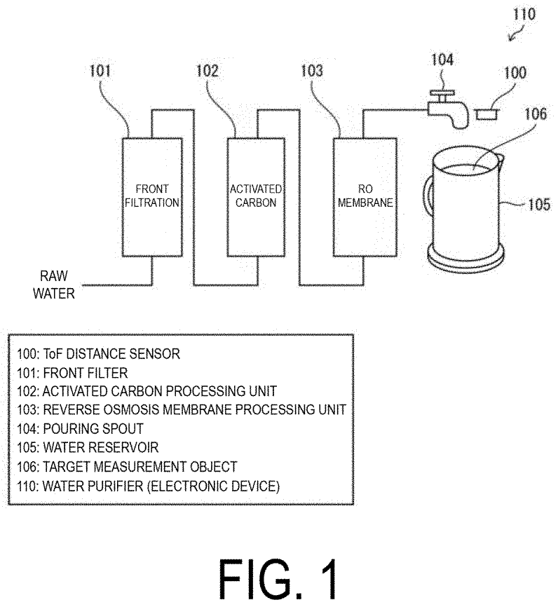

A first embodiment of the disclosure will be described below in detail with reference to FIGS. 1 to 6. In the first embodiment, a ToF distance sensor 100, which is an aspect of the disclosure, and a water purifier 110, which is an aspect of an electronic device of the disclosure using the ToF distance sensor 100, will be described.

### Configuration of Water Purifier 110

As illustrated in FIG. 1, the water purifier 110 includes a front filter 101, an activated carbon processing unit 102, a reverse osmosis membrane processing unit 103, a pouring spout 104, a water reservoir 105, and the ToF distance sensor 100. The reverse osmosis membrane is also referred to as an RO membrane, and the reverse osmosis membrane processing unit 103 is also referred to as an RO membrane processing unit. In the water purifier 110, raw water passes through the front filter 101, the activated carbon processing unit 102, and the reverse osmosis membrane processing unit 103 in that order. The liquid having passed through the reverse osmosis membrane processing unit 103 is poured into the water reservoir 105 through the pouring spout 104 as purified water or filtrate, and is stored directly in the water reservoir 105, which is detachable.

Since the water reservoir 105 is configured to be detachable from the water purifier 110, the water purifier 110 employs a configuration in which the filtrate is poured from above the water reservoir 105. In addition, in the water purifier 110, a flow rate of the liquid released from the pouring spout 104 is made to be as large as possible in order to shorten the time until a level of full water is reached.

Because of this, in the water purifier 110, the liquid surface fluctuation of the water stored in the water reservoir 105 is larger than that in other typical electronic devices having a water storage unit such as a humidifier. In FIG. 1, the water stored in the water reservoir 105 is a target measurement object 106 of the ToF distance sensor 100. In the water purifier 110, the ToF distance sensor 100 is disposed at approximately the same height as the pouring spout 104 in order to detect a position of the liquid surface in the water purifier 110.

### Configuration of ToF Distance Sensor 100

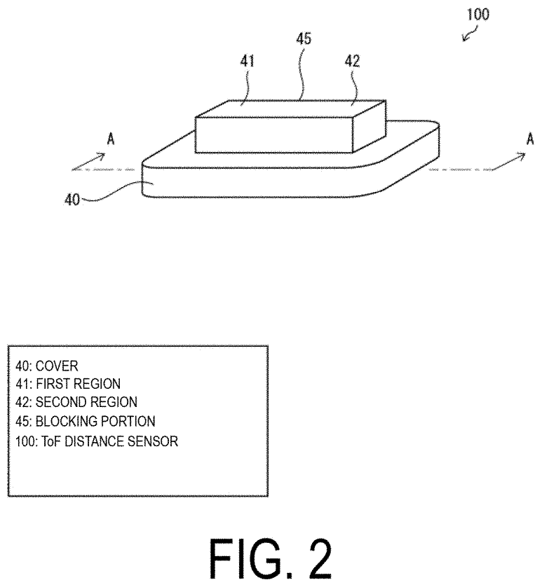

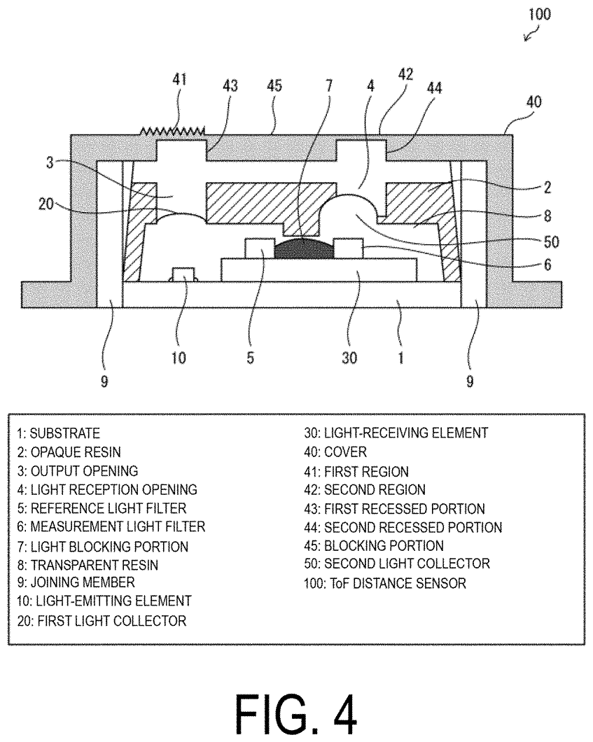

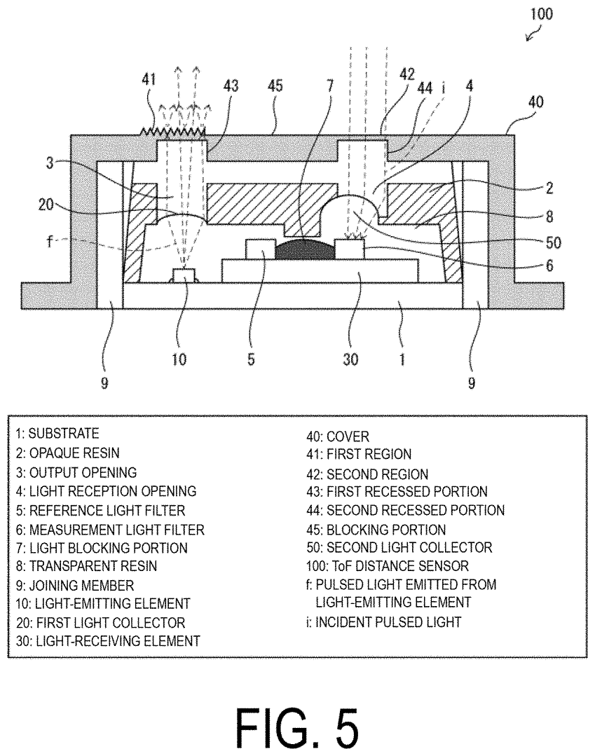

The ToF distance sensor 100 is a sensor configured to detect a distance by using a Time of Flight scheme. The ToF distance sensor 100 of the first embodiment includes a light-emitting element 10, a first light collector 20, a light-receiving element 30, a cover 40, and a second light collector 50 (see FIGS. 4 and 5). The external shape of the ToF distance sensor 100 is illustrated in FIG. 2.

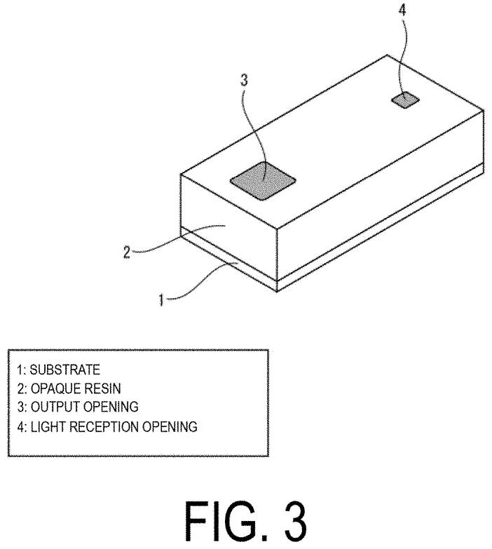

The ToF distance sensor 100 includes, on the cover 40, a first region 41 and a second region 42 through which pulsed light passes, as illustrated in FIG. 2. Furthermore, the cover 40 includes a blocking portion 45 configured to block the transmission of pulsed light at least between the first region 41 and the second region 42. The ToF distance sensor 100 in a state where the cover 40 is removed therefrom is illustrated in FIG. 3.

As illustrated in FIG. 3, the ToF distance sensor 100 employs a configuration in which an opaque resin 2 including a light blocking material is disposed on a substrate 1 while covering the substrate 1. Further, the ToF distance sensor 100 includes an output opening 3 and a light reception opening 4 in the opaque resin 2. The output opening 3 and the light reception opening 4 are constituted by through-holes that pass through the opaque resin 2.

The opening diameter of the output opening 3 is larger than the opening diameter of the light reception opening 4. Sizes of the external shape of the ToF distance sensor 100 in a state where the cover 40 is removed are as follows. The thickness is approximately in a range of from 0.3 mm to 3 mm. The long side thereof is approximately in a range of from 2 mm to 10 mm, and the short side thereof is approximately in a range of from 1 mm to 5 mm. FIG. 4 illustrates a cross-sectional view taken along the line A-A in FIG. 2. In the ToF distance sensor 100, a transparent resin 8 is filled between the opaque resin 2 and the substrate 1. In the interior of the ToF distance sensor 100 filled with the transparent resin 8, the light-emitting element 10 is provided.

### Configuration of Light-Emitting Element 10

The light-emitting element 10 is preferably a vertical cavity surface emitting laser (VCSEL) capable of ultrahigh speed modulation. The light-emitting element 10 may select, for example, infrared light in the 940 nm band as a light emission wavelength. When the VCSEL is used for the light-emitting element 10, pulsed light emitted from the light-emitting element 10 spreads out from the optical axis of the light-emitting element 10. For example, the pulsed light has a directivity of 15 degrees in terms of half width at half maximum. The pulsed light in this case is also referred to as laser light.

Hereinafter, pulsed light that is emitted from the light-emitting element 10 and then reaches the target measurement object 106 (see FIG. 1) is referred to as a “light emission pulse”. The light emission pulse includes pulsed light inside the ToF distance sensor 100 and pulsed light outside the ToF distance sensor 100. The pulsed light reflected at the target measurement object 106 (see FIG. 1) is referred to as “reflected light”. Pulsed light that is incident toward the light-receiving element 30 is referred to as a “light reception pulse”.

### Configuration of First Light Collector 20

The first light collector 20 collects the pulsed light emitted from the light-emitting element 10 inside the ToF distance sensor 100. Specifically, the first light collector 20 is a convex lens projecting from the light-emitting element 10 side toward the output opening 3 side.

The first light collector 20 is made of a material having a light-transmitting property such as an epoxy, similar to the transparent resin 8. The first light collector 20 is in contact with a lower portion of the output opening 3 and is constituted integrally with the transparent resin 8. However, the first light collector 20 may be constituted by a different member from the transparent resin 8. The outermost portion of the projection of the first light collector 20 is located on the central axis of the output opening 3. The center of the light-emitting element 10 is located on the focal point of the first light collector 20. The light-emitting element 10 and the light-receiving element 30 are die-bonded onto the substrate 1 at a predetermined interval.

### Configuration of Light-Receiving Element 30

The light-receiving element 30 is a semiconductor chip configured to receive pulsed light. The light-receiving element 30 is preferably provided with an array of single photon avalanche photo diodes (SPADs) able to detect faint light at ultrahigh speed, as a light receiving unit. Two filters constituted of a reference light filter 5 and a measurement light filter 6 are provided on the light receiving unit of the light-receiving element 30. The light receiving unit for reference light is disposed directly underneath the reference light filter 5, and the light receiving unit for measurement light is disposed directly underneath the measurement light filter 6.

The reference light filter 5 and the measurement light filter 6 are glass filters configured to cut visible light. It is preferable that a band-pass filter configured to selectively transmit a light emission wavelength of the light-emitting element 10 be provided on a surface of the reference light filter 5. The reference light filter 5 is disposed near the light-emitting element 10.

A light blocking portion 7 configured to block pulsed light is provided between the reference light filter 5 and the measurement light filter 6. The transparent resin 8 is filled between the reference light filter 5 and the light-emitting element 10 to form a path of the pulsed light. This path is referred to as a “reference light path” hereinafter. The light-receiving element 30 receives pulsed light emitted from the light-emitting element 10 at the light receiving unit of the reference light via the reference light path. Meanwhile, the light-receiving element 30 receives a light reception pulse at the light receiving unit of the measurement light.

Configuration of Cover 40

The cover 40 is provided for protection of the ToF distance sensor 100. The cover 40 is provided over an upper face of the opaque resin 2 with a predetermined distance therebetween. The cover 40 is fixed by providing two joining members 9 appropriately on both side surfaces of the opaque resin 2 as well as the substrate 1 while preventing the ToF distance sensor 100 from becoming wet.

The predetermined distance between the cover 40 and the opaque resin 2 may be selected within a range of from 0 mm to 5 mm. The thickness of the cover 40 may be selected within a range of from 0.5 mm to 3 mm. Typically, the distance is 0.7 mm and the thickness is 1 mm.

In the cover 40, materials, thicknesses, and the like are adjusted to transmit pulsed light in the first region 41 corresponding to the output opening 3 and the second region 42 corresponding to the light reception opening 4. In FIG. 4, the first region 41 is provided on one of the front and rear surfaces of the cover 40, and the thickness of the cover 40 is adjusted by providing a first recessed portion 43 on the other surface opposite to the surface where the first region 41 is provided.

The first recessed portion 43 is provided on the other surface located on the inner side. The first region 41 covers the output opening 3 and the light-emitting element 10. The second region 42 is provided on one of the front and rear surfaces of the cover 40, and the thickness of the cover 40 is adjusted by providing a second recessed portion 44 on the other surface opposite to the surface where the second region 42 is provided. The second region 42 covers the light reception opening 4, and the light receiving unit for the measurement light and the vicinity thereof.

Configuration of First Region in First Embodiment

In the cover 40, the first region 41 is a scattering region configured to scatter pulsed light. In the first region 41 as the scattering region, pulsed light not only passes through the cover 40, but also is scattered. The first region 41 as the scattering region is configured to include irregularities on one surface thereof. Specifically, a rough texture is given to one surface located on the outer side of the first region 41, thereby forming the irregularities in the scattering region.

The second region 42 is a transmissive region configured to simply transmit pulsed light. Each of the front and rear surfaces of the cover 40 in the second region 42 as the transmissive region is formed by a plane. Specifically, the second region 42 is provided on one surface located on the outer side of the cover 40. On the other hand, the second recessed portion 44 is provided on the other surface located on the inner side of the cover 40.

Configuration of Second Light Collector

The second light collector 50 collects light reception pulses. Specifically, the second light collector 50 is a convex-type light collection lens that projects from the light-receiving element 30 side toward the light reception opening 4 side. The second light collector 50 is made of a material having a light-transmitting property such as an epoxy, similar to the transparent resin 8. The second light collector 50 has a larger diameter than that of the light reception opening 4, and has a height that is approximately half of a height in a vertical direction from the transparent resin 8 to the light reception opening 4, in the longitudinal cross-sectional view in FIG. 4.

The second light collector 50 is in contact with the light reception opening 4, and is constituted integrally with the transparent resin 8. However, the second light collector 50 may be constituted by a different member from the transparent resin 8. The light receiving unit for the measurement light is located on the focal point of the second light collector 50. However, the outermost portion of the projection of the second light collector 50 is disposed offset from the central axis of the light reception opening 4 toward the light blocking portion 7 side. The opaque resin 2 covers part of the second light collector 50 corresponding to the upper side of the light blocking portion 7.

Optical Relationship on Light Emission Side in First Embodiment

In an optical path of the light emission pulses in the ToF distance sensor 100, there exists the first light collector 20 next to the light-emitting element 10, and, after passing through the output opening 3 and the first recessed portion 43, there exists the first region 41 as the scattering region next to the first light collector 20. In other words, the optical relationship on the light emission side is set in the order of the light-emitting element 10, the first light collector 20, and the first region 41 serving as the scattering region.

Optical Relationship on Light Reception Side in First Embodiment

In an optical path of the light reception pulses in the ToF distance sensor 100, there exists the second light collector 50 next to the second region 42 serving as the transmissive region. Next to the second light collector 50, the measurement light filter 6 and the light receiving unit for the measurement light of the light-receiving element 30 are present in that order.

### Water Level Detection Action

Next, a water level detection action using the ToF distance sensor 100 will be described in detail with reference to FIGS. 1 and 5. The water level detection action is an action of detecting the position of a liquid surface of the target measurement object 106 (see FIG. 1) with the ToF distance sensor 100.

The light-emitting element 10 emits short pulse light (pulsed light) toward the outside. As illustrated in FIG. 5, pulsed light that is emitted from the light-emitting element 10 and spreads out from the optical axis of the light-emitting element 10 passes through the first light collector 20, whereby light energy passing through the output opening 3 is collected in a direction parallel to the optical axis of the light-emitting element 10.

Light emission pulses f collected in the manner described above pass through the first recessed portion 43, and are output to the outside while being scattered through the first region 41. Through the cover 40, the light emission pulses f are irradiated onto the target measurement object 106 (see FIG. 1). Although not illustrated, part of the pulsed light is received as the reference light by the light-receiving element 30 through a reference light path inside the ToF distance sensor 100.

The light emission pulses f released to the outside of the ToF distance sensor 100 through the first light collector 20 and the first region 41 are reflected at a measurement surface of the target measurement object 106 (see FIG. 1). The reflected light at the measurement surface such as the liquid surface of the water reservoir 105 (see FIG. 1) returns to the ToF distance sensor 100. Part of the reflected light passes through the second region 42 as the measurement light, then enters the second light collector 50, the measurement light filter 6, and the light receiving unit for the measurement light of the light-receiving element 30 in that order, and is received. The received light refers to light reception pulses i.

More specifically, the light reception pulses i are incident toward the light-receiving element 30 through the second region 42. The light reception pulses i having entered through the second region 42 pass through the second recessed portion 44 and the light reception opening 4, and are gathered by the second light collector 50 onto the light receiving unit for the measurement light. The gathered light reception pulses i are detected by the light-receiving element 30. At this time, based on the detection by the light-receiving element 30 via the light receiving unit for the reference light and the light receiving unit for the measurement light, the water level detection action is performed to detect the position of the liquid surface of the target measurement object 106 (see FIG. 1).

In the water level detection action, when the measurement surface is separated from the ToF distance sensor 100, the time required for reciprocating motion of the light (flight time) becomes longer. Further, when the measurement surface is separated from the ToF distance sensor 100, the length of time from the detection of the reference light by the light-receiving element 30 to the detection of the reflected light by the light-receiving element 30 increases.

The ToF distance sensor 100 measures flight times of a large number of beams of the short pulse light and performs statistical processing on the measured flight times, thereby suppressing the effects of stray light. According to the ToF distance sensor 100, the timing at which the reference light is detected is taken as a reference time, and the flight time is relatively measured. With this configuration, it possible to enable accurate measurement of distance.

Alteration Test of Light Emission Side Configuration

The light emission side configuration refers to a configuration able to establish the optical relationship on the light emission side. In the first embodiment, the light emission side configuration includes the light-emitting element 10, the first light collector 20, the output opening 3, the first recessed portion 43, and the first region 41. When manufacturing the ToF distance sensor 100 of the first embodiment, the light emission side configuration was variously altered, and distance detection results obtained by the ToF distance sensor 100 were examined.

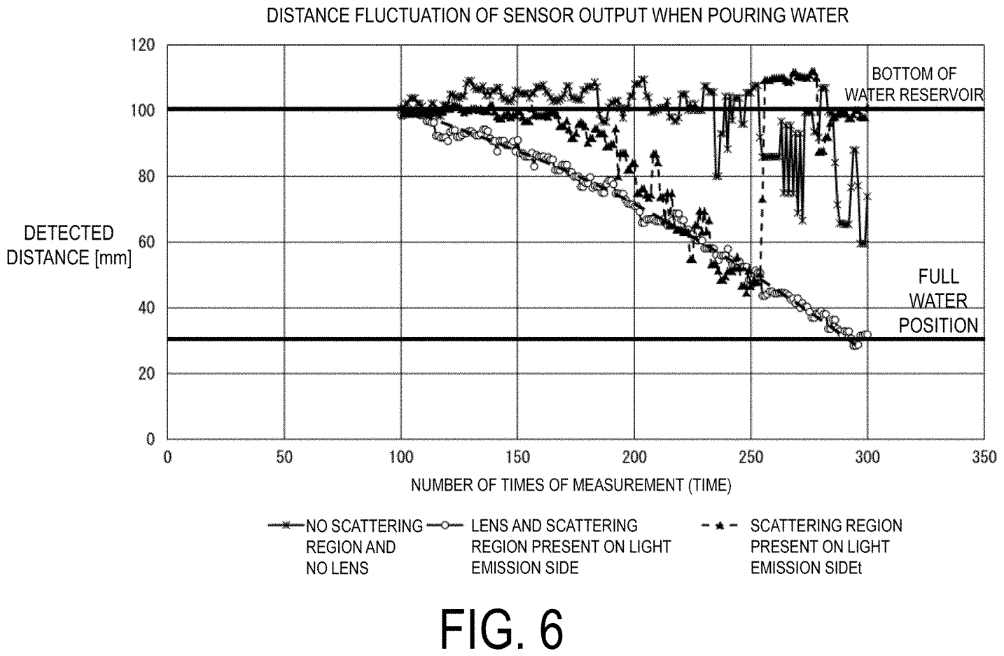

FIG. 6 is a graph showing a measurement time and a distance fluctuation of output of the ToF distance sensor 100 when pouring water into the water purifier 110. The broken line in FIG. 6 indicates an ideal fluctuation. That is, a detection distance of 100 mm to the bottom of the water reservoir 105 (see FIG. 1) is detected when there is no water, and a curved line is depicted which gradually declines until reaching a full water position as the water is poured.

### Alteration Test Method and Evaluation Method

In this alteration test, the measurement of distance was performed using the ToF distance sensor 100 while pouring water into the water reservoir 105 (see FIG. 1), and the output distance fluctuation was evaluated. The evaluation method was as follows. When the output distance fluctuation depicted a curved line like the ideal fluctuation, it was determined that the distance detection was performed correctly.

### Contents of Light Emission Side Configurations of First Embodiment and Comparative Examples

The light emission side configurations used in the alteration test were as follows.

### First Embodiment

Lens and scattering region present on the light emission side: that is, equipped with the same configuration as that of the ToF distance sensor 100 according to the first embodiment.

### First Comparative Example

No scattering region and no lens: in a first comparative example, the first region 41 of the ToF distance sensor 100 according to the first embodiment was changed to a transmissive region. Furthermore, in the first comparative example, the first light collector 20 according to the first embodiment was not provided, and a portion between the output opening 3 and the transparent resin 8 was changed to a plane. The first comparative example had the same configuration as the ToF distance sensor 100 except for the above-mentioned changes.

### Second Comparative Example

Scattering region present on the light emission side: the second comparative example had the same configuration as the ToF distance sensor 100 according to the first embodiment except that the first light collector 20 of the ToF distance sensor 100 was not provided and a portion between the output opening 3 and the transparent resin 8 was changed to a plane.

### Results of ToF Distance Sensor 100 According to First Embodiment

In the case of the first embodiment with a lens and a scattering region on the light emission side, the first region 41 and the first light collector 20 were included in the light emission side configuration. In this case, as shown in FIG. 6, the output of the ToF distance sensor 100 indicates the same result as the ideal fluctuation, and the distance detection is correctly performed. From the above experimental facts, it was found that the ToF distance sensor 100 according to the first embodiment exhibits high accuracy even in a case where the water level suddenly fluctuates when water is poured.

### Results of Comparative Examples

In the case of the first comparative example with no scattering region and no lens, the first region 41 as the scattering region and the first light collector 20 were not included in the light emission side configuration. In this case, as shown in FIG. 6, the output of the ToF distance sensor 100 fluctuates sharply, and the distance detection is not correctly performed.

In the case of the second comparative example with a scattering region on the light emission side, that is, in the case where the scattering region was provided in the first region 41 in the light emission side configuration, the distance detection was performed almost correctly when the water level was low, as shown in FIG. 6. However, when the water level was high, the output of the ToF distance sensor 100 fluctuated sharply, and the distance detection was not performed correctly. From the above experimental facts, it was found that the distance detection was not performed correctly in some cases in the ToF distance sensors of the first and second comparative examples, and the accuracy thereof was worse than that of the first embodiment.

In the ToF distance sensor of the first comparative example, a scattering region and a lens were not provided in the light emission side configuration. As described above, in the case where the light emission side configuration lacked both the first region 41 serving as the scattering region and the first light collector 20, the accuracy was the lowest. In the ToF distance sensor of the second comparative example, a lens was not provided in the light emission side configuration. As described above, even when the first region 41 serving as the scattering region was provided, in the case where the first light collector 20 was not provided, the accuracy was poor.

In the first comparative example, the liquid surface ripples sharply in the full water state, and the amount of light the water reservoir 105 receives is large due to specular reflection. Because of this, a detection signal ratio is reversed and the bottom face of the water reservoir 105 is detected. In order to improve the above issue, even when the scattering region is provided on the light emission side to increase the region of irradiation on the liquid surface as in the second comparative example, a liquid surface detection signal cannot be obtained. The reason for this is considered as follows. As the vertical cavity surface emitting laser (VCSEL) spreads out from the optical axis, a delay in radiation time occurs, and a value of time obtained by adding the radiation delay time to the original propagation time of light to the liquid surface becomes a propagation time of the wide angle component, so that the wide angle component does not contribute to serving as the liquid surface detection signal. As a result, the detection signal is largely affected by the light beam behavior of only the optical axis component. As a result, the effect of the light emission scattering is not obtained, and the liquid surface signal cannot be obtained. To improve the above situation, the first light collector 20 is provided between the light-emitting element 10 and a rough texture panel included in the first region 41 so as to average the variation in light emission radiation times.

Specifically, it is assumed that t1, t2, and the like each represent a radiation time per unit angle, and n represents a light collection rate by the lens, and the radiation times that differ for each unit angle are averaged as expressed by a formula of (t1+t2+ . . . )/n. With this, the radiation times of the components having been scattered by the rough texture are averaged, so that it is possible to obtain only a difference in propagation time between time at the full water and time at the bottom of the water reservoir 105, whereby the characteristics are further improved as illustrated in FIG. 6.

That is, as illustrated in FIG. 6, in the case of the first embodiment including the lens and the scattering region on the light emission side, the characteristics are further improved than in the case of the second comparative example including the scattering region on the light emission side.

Specifically, as illustrated in FIGS. 4 and 5, the center of the light-emitting element 10 is disposed on the focal point position of the first light collector 20. As a result, the pulsed light that is emitted from the light-emitting element 10 and spreads out from the optical axis of the light-emitting element 10 is converted to parallel light, so that the radiation time variation of light emission is averaged. The second light collector 50 on the light reception side collects the light reception pulses having been reflected at the target measurement object 106 and returned therefrom, so as to exhibit an effect where the light reception pulses are gathered onto the light-receiving element 30 via the light receiving unit for the measurement light.

As described above, according to the ToF distance sensor 100, even when the liquid surface of the target measurement object 106 fluctuates, it is possible to accurately and stably detect the transition of the liquid surface. According to the water purifier 110, even when the liquid surface of the target measurement object 106 fluctuates, the transition of the liquid surface can be accurately and stably detected.

### Second Embodiment

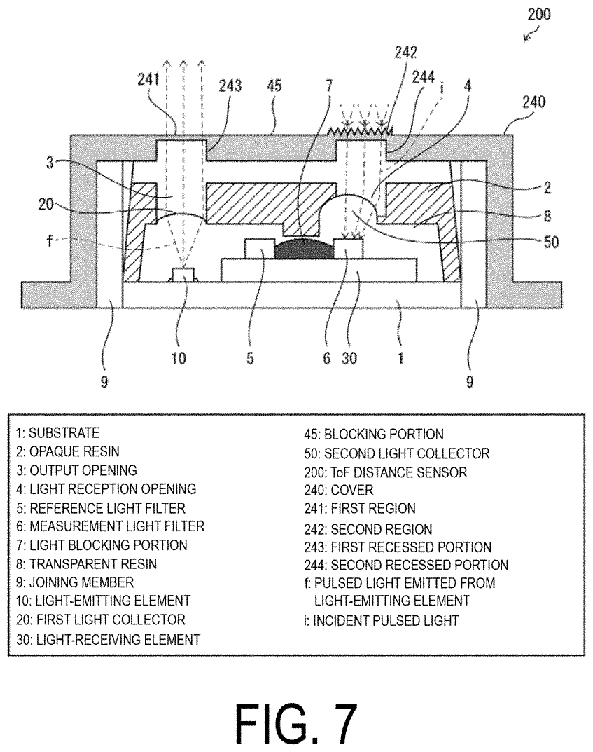

A second embodiment of the disclosure will be described below with reference to FIG. 7. Note that, for convenience of explanation, components having the same function as those described in the above-described embodiment will be denoted by the same reference signs, and descriptions of those components will be omitted.

A ToF distance sensor 200 of the second embodiment has the same configuration as the ToF distance sensor 100 of the first embodiment except that first and second regions of a cover differ from those of the first embodiment, as illustrated in FIG. 7. In other words, the ToF distance sensor 200 includes the light-emitting element 10, the first light collector 20, the light-receiving element 30, the second light collector 50, and a cover 240.

### Configuration of Cover 240

As illustrated in FIG. 7, the cover 240 includes a first region 241 configured to cover the output opening 3 and the light-emitting element 10, and a second region 242 configured to cover the light reception opening 4, and a light receiving unit for measurement light and the vicinity thereof. The first region 241 in the cover 240 is a transmissive region configured to simply transmit pulsed light. The first region 241 as the transmissive region constitutes one surface located on the outer side by a plane. The other surface located on the inner side is formed with a first recessed portion 243, so that both front and rear surfaces of the first region 241 are constituted by the planes.

The first recessed portion 243 corresponds to the first recessed portion 43 of the first embodiment. On the other hand, the second region 242 is a scattering region configured to scatter pulsed light. The second region 242 as the scattering region is configured to include irregularities on one surface thereof located on the outer side, similar to the first region 41 of the first embodiment. This exhibits an effect of scattering. A second recessed portion 244 is provided on the other surface located on the inner side of the cover 240. The second recessed portion 244 corresponds to the second recessed portion 44 of the first embodiment.

### Optical Relationship on Light Emission Side in Second Embodiment

In an optical path of light emission pulses f in the ToF distance sensor 200, there exists the first light collector 20 next to the light-emitting element 10, and there exists the first region 241 as the transmissive region next to the first light collector 20. In other words, the optical relationship on the light emission side is set in the order of the light-emitting element 10, the first light collector 20, and the first region 241 serving as the transmissive region.

### Optical Relationship on Light Reception Side in Second Embodiment

In an optical path of light reception pulses i in the ToF distance sensor 200, there exist the second light collector 50 next to the second region 242 as the scattering region, the measurement light filter 6 next to the second light collector 50, and a light receiving unit for the measurement light of the light-receiving element 30 in that order.

Since the second region 242 of the cover 240 is the scattering region, pulsed light that reaches the cover 240 is dispersed. In other words, since the pulsed light is scattered at the second region 242, a situation in which the light reception amount is concentrated onto a fixed location of the light receiving unit is suppressed. With this, in a case where diffused reflection occurs due to the fluctuation of the liquid surface of the target measurement object 106 (see FIG. 1), it is possible to prevent the influence of the deflection of the diffusely reflecting pulsed light with respect to the light receiving unit, the refraction thereof toward the outside of the light receiving unit, or the like. In addition, according to the ToF distance sensor 200, it is possible to prevent reflection at the second region 242 of the cover 240.

A larger number of light reception pulses i having passed through the second region 242 than in the case of the first embodiment are collected by the second light collector 50 on the light reception side, so as to be gathered onto the light-receiving element 30. That is, in the second region 242, the pulsed light that reaches the second light collector 50 increases in quantity in comparison with a configuration of passing through the transmissive region, and the incidence of various pulsed light from unwanted directions on the light-receiving element 30 is prevented by the second light collector 50 to improve sensitivity. Due to this, with the ToF distance sensor 200, even when the liquid surface of the target measurement object 106 (see FIG. 1) fluctuates, it is possible to accurately and stably detect the transition of the liquid surface.

### Third Embodiment

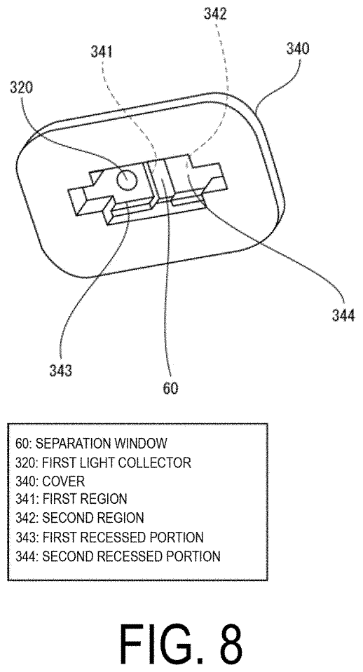

A third embodiment of the disclosure will be described below with reference to FIGS. 8 and 10. A ToF distance sensor 300 of the third embodiment has the same configuration as the ToF distance sensor 100 of the first embodiment except that a cover and a first light collector differ from those of the first embodiment, as illustrated in FIGS. 8 and 10. In other words, the ToF distance sensor 300 of the third embodiment includes the light-emitting element 10, a first light collector 320, the light-receiving element 30, the second light collector 50, and a cover 340.

### Configuration of Cover 340

The cover 340 includes the first light collector 320 and a separation window 60, as illustrated in FIG. 8. In the cover 340, a first region 341 corresponds to the first region 41 of the first embodiment. A second region 342 corresponds to the second region 42 of the first embodiment. A first recessed portion 343 corresponds to the first recessed portion 43 of the first embodiment. A second recessed portion 344 corresponds to the second recessed portion 44 of the first embodiment.

### Configuration of First Light Collector 320 in Third Embodiment

The first light collector 320 is a convex lens projecting from the first recessed portion 343 side toward the output opening 3 side. The first light collector 320 is made of a material having a light-transmitting property such as an epoxy, similar to the transparent resin 8. The first light collector 320 is a different member from the transparent resin 8. The first light collector 320 is integrally formed in the first recessed portion 343. However, the first light collector 320 may be constituted by a different member from the first recessed portion 343.

In the third embodiment, the first light collector 320 is not formed in the output opening 3 and in the transparent resin 8. The outermost portion of a projection of the first light collector 320 is located on an extended line of the central axis of the output opening 3. The center of the light-emitting element 10 is located on the focal point of the first light collector 320. As a result, laser light that spreads out from the optical axis of the light-emitting element 10 is converted to parallel light in the first light collector 320, so that the radiation time variation of light emission is averaged.

### Configuration of Separation Window 60

The separation window 60 has a square through-hole that passes through the inner side and outer side of the cover 340, and is constituted by a rectangular parallelepiped made of a light-transmitting material. The separation window 60 is formed between the first region 341 and the second region 342, and has a height extending from the cover 340 to the transparent resin 8. A length in a longitudinal direction of the separation window 60 is equal to a length in a short-hand direction of the ToF distance sensor 300 in a state where the cover 340 is removed. A length in the short-hand direction of the separation window 60 is equal to a length between an inner side end portion of the first region 341 and an inner side end portion of the second region 342. The ToF distance sensor 300 adopts a configuration in which dirt, dust, and the like are prevented from entering through the separation window 60 into the interior.

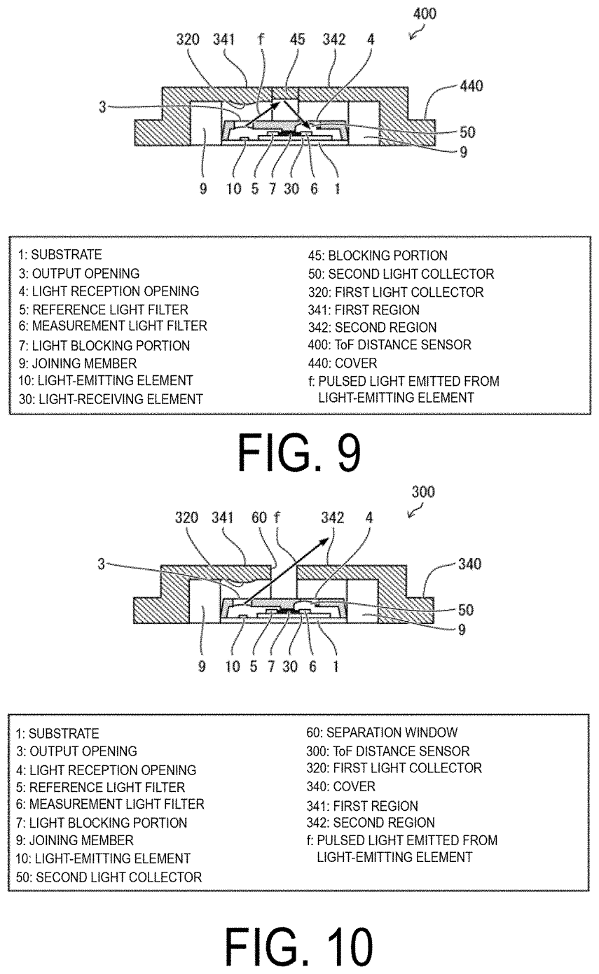

As a modified example of the cover 340, a cover 440 not including the separation window 60 is illustrated in FIG. 9. A ToF distance sensor 400 of the modified example has the same configuration as the ToF distance sensor 300 of the third embodiment except for a difference in presence/absence of the separation window 60, as illustrated in FIG. 9. That is, the ToF distance sensor 400 provided with the cover 440 does not include the separation window 60 but includes a blocking portion 45 in the cover 440, as illustrated in FIG. 9. The ToF distance sensor 400 does not include the first light collector 20 as included in the first embodiment, and therefore, in some cases, some light emission pulses f in the interior of the ToF distance sensor 400 reach the cover 440 through the output opening 3, and then reflect off the blocking portion 45 to reach the light-receiving element 30. When this happens, crosstalk components are generated.

Specifically, when the light-emitting element 10 is a VCSEL, pulsed light with a directivity angle of 30 degrees or larger, for example, of the pulsed light that is emitted from the light-emitting element 10 and has spread out from the optical axis of the light-emitting element 10 reflects off the blocking portion 45 without passing through the first light collector 320 from the output opening 3. Then, the pulsed light passes between the opaque resin 2 and the cover 440 of the ToF distance sensor 400, and comes to be incident on the light-receiving element 30 via the second light collector 50 from the light reception opening 4.

In contrast, in the case of the cover 340 having the separation window 60, as illustrated in FIG. 10, the light emission pulse f leaves from the separation window 60 without being reflected at the cover 340 due to the separation window 60. Thus, with the ToF distance sensor 300 of the third embodiment, crosstalk components can be further decreased.

### Fifth Embodiment

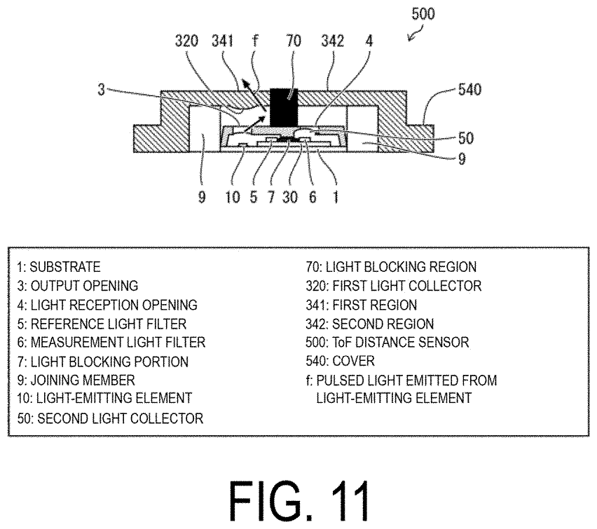

A fifth embodiment of the disclosure will be described below with reference to FIG. 11. A ToF distance sensor 500 of the fifth embodiment has the same configuration as the ToF distance sensor 100 of the first embodiment except that a cover and a first region differ from those of the first embodiment, as illustrated in FIG. 11. In other words, the ToF distance sensor 500 of the fifth embodiment includes the light-emitting element 10, the first light collector 320, the light-receiving element 30, the second light collector 50, and a cover 540.

### Configuration of Cover 540

The cover 540 includes a light blocking region 70. The light blocking region 70 is formed of a rectangular parallelepiped made of a light blocking material. The light blocking region 70 is provided between the first region 341 and the second region 342, and has a height extending from the cover 540 to the transparent resin 8. A length in a longitudinal direction of the light blocking region 70 is equal to a length in a short-hand direction of the ToF distance sensor 500 in a state where the cover 540 is removed. A length in the short-hand direction thereof is equal to a length between an inner side end portion of the first region 341 and an inner side end portion of the second region 342.

In the fifth embodiment as well, because the first light collector 20 as in the first embodiment is not included similar to the modified example of the third embodiment, pulsed light that is emitted from the light-emitting element 10 and spreads out from the optical axis of the light-emitting element 10 is generated. However, in the fifth embodiment, pulsed light with a directivity angle of 30 degrees or larger, for example, of the above-mentioned pulsed light is reflected at the light blocking region 70 before reaching the cover 540 from the output opening 3.

The reflected pulsed light passes through the first region 341 and is launched toward the outer side of the ToF distance sensor 500. Thus, pulsed light that is emitted from the light-emitting element 10 and spreads out from the optical axis of the light-emitting element 10 is prevented from entering the light reception side configuration inside the ToF distance sensor 500 by the light blocking region 70. With this, according to the ToF distance sensor 500, the crosstalk components can be decreased.

### Sixth Embodiment

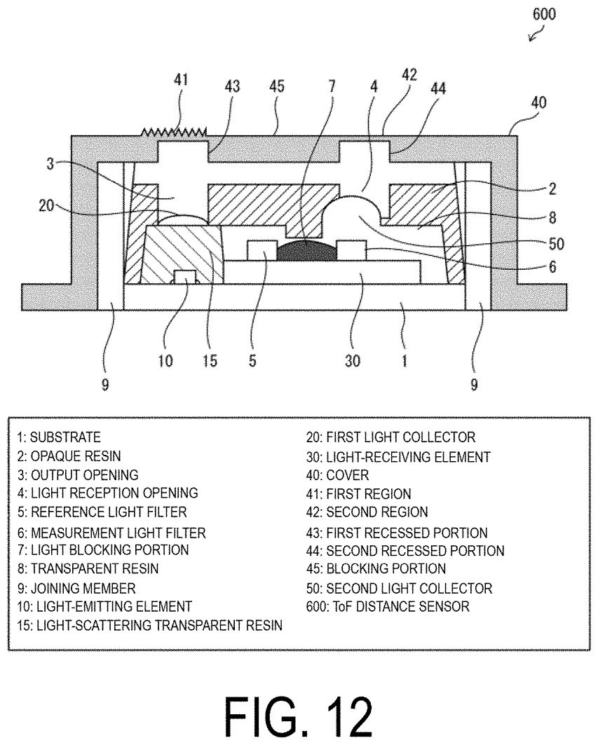

A sixth embodiment of the disclosure will be described below with reference to FIG. 12. A ToF distance sensor 600 of the sixth embodiment has the same configuration as the ToF distance sensor 100 of the first embodiment except that a constitution in which a light-scattering transparent resin 15 is set over the light-emitting element 10 by potting is employed, as illustrated in FIG. 12. The light-scattering transparent resin 15 is a resin in which a scattering material is mixed into a silicone resin. Pulsed light emitted upward from the light-emitting element 10 passes through the light-scattering transparent resin 15 to be scattered.

When the light-scattering transparent resin 15 is used as in the sixth embodiment, a structure in which irregularities are provided only on a front face of the first region 41, serving as a scattering region of the cover 40, can be manufactured by molding. In the case where the material of the cover 40 is glass or a light-transmitting resin, the first region 41 can be manufactured by using a chemical processing technique such as etching treatment of the surface. Alternatively, the scattering region of the first region 41 can be manufactured by using a physical processing technique such as sandblasting or grinding.

In the case where the material of the cover 40 is glass or a light-transmitting resin, the first region 41 can be manufactured by forming irregularities only on the front face of the first region 41 serving as the scattering region. The first region 41 serving as the scattering region is not limited to being constituted by providing irregularities on a surface of a plate member, and may be obtained by being made of a material that itself scatters light, for example, a material into which substances having different refraction indices are mixed. As an indicator of the degree of scattering, a haze specified by the Japanese Industrial Standards JIS K 7136 may be used. The haze suitable in the sixth embodiment is 10% to 95%. Typically, the haze may be 90%.

### Modified Example

The ToF distance sensor according to an aspect of the disclosure is applicable to devices other than the water purifier 110 of the first embodiment. For example, the ToF distance sensor is applicable to detection of a residual amount in a fuel tank for kerosene or the like, water level detection in a humidifier, water level detection in a coffee maker, detection of a residual amount in a medical device (drip infusion or the like), and the like.

In the above-described embodiments, a case in which the light-emitting element 10 is a vertical cavity surface emitting laser is exemplified, but the present disclosure is not limited thereto. For example, the light-emitting element 10 may be another light source such as an edge emitting laser. In this case, the disclosure is not limited to the wavelength band cited in the embodiments; that is, infrared light in other wavelength bands, visible light in addition to infrared light, and the like may also be used.

Although an example in which the first light collectors 20 and 320 are convex lenses is cited, the disclosure is not limited thereto. Each of the first light collectors 20 and 320 may have any configuration as long as the pulsed light emitted from the light-emitting element is collected. Each of the first light collectors 20 and 320 may be, for example, a lens other than a convex lens, or a concave mirror.

Furthermore, it is only required that the first light collectors 20 and 320 are provided between the light-emitting element and the first region, and thus the first light collectors 20 and 320 are not limited to being provided on the lower side of the output opening and in the first recessed portion as in the above-described embodiments. In this case, similar to the above-described embodiments, pulsed light that is emitted from the light-emitting element 10 and spreads out from the optical axis of the light-emitting element 10 is given directivity, so that the energy is concentrated in a direction toward the target measurement object, thereby achieving excellent efficiency.

Although an example in which the second light collector 50 is a convex-type light collection lens is cited in the above-described embodiments, the disclosure is not limited thereto. The second light collector 50 may have any configuration as long as pulsed light that is incident toward the light-receiving element is collected. The second light collector 50 may be, for example, a convex lens, a lens other than a convex lens, or a concave mirror.

It is only required that the second light collector 50 be provided between the light-receiving element and the second region, and therefore the second light collector 50 is not limited to being provided on the lower side of the light reception opening as in the above-described embodiments. For example, the second light collector may be provided on the upper side of the light receiving opening or may be provided in the second recessed portion. In this case, similar to the above-described embodiments, light reception pulses are given directivity and various pulsed light is unlikely to enter from unwanted directions, and thus sensitivity is improved.

In the embodiments described above, an example is cited in which, when the first region 41, 241, 341 is a scattering region, irregularities are provided on one surface thereof, but the disclosure is not limited thereto. In the scattering region, for example, irregularities may be provided on both the surfaces thereof including the other surface. The effect of scattering is not limited to being obtained by providing irregularities on one surface, and may be obtained by providing irregularities on both the surfaces including the other surface.

Likewise, in the embodiments described above, an example is cited in which, when the second region 42, 242, 342 is a scattering region, irregularities are provided on one surface thereof, but the disclosure is not limited thereto. In the scattering region, for example, irregularities may be provided on both the surfaces thereof including the other surface. The effect of scattering is not limited to being obtained by providing irregularities on one surface, and may be obtained by providing irregularities on both the surfaces including the other surface.

The separation window 60 and the light blocking region 70 are provided between the first region and the second region, and are not limited in any way to the shapes and structures of the embodiments described above as long as the following functions are enabled. The separation window 60 may have any shape and structure as long as pulsed light emitted from the light-emitting element leaves therethrough without being reflected by the cover. The light blocking region 70 may have any shape and structure as long as the pulsed light from the light-emitting element is prevented from entering the light reception side configuration and is blocked.

### Supplement

A ToF distance sensor according to a first aspect of the disclosure includes a light-emitting element configured to emit pulsed light; a first light collector configured to collect the pulsed light emitted from the light-emitting element; a light-receiving element; and a cover provided with a first region configured to output the pulsed light collected by the first light collector to an outside, and a second region configured to cause the pulsed light reflected by a target measurement object to be incident toward the light-receiving element, wherein the first region is configured to be a scattering region that scatters the pulsed light.

In this case, the pulsed light that spreads out from the optical axis of the light-emitting element is converted to parallel light by the first light collector, so that the radiation time variation of light emission is averaged. The averaged light emission pulses reflect off the target measurement object and part of the reflected light is detected by the light-receiving element as light reception pulses. Due to this, even when a liquid surface of the target measurement object fluctuates, it is possible to accurately and stably detect the transition of the liquid surface.

A ToF distance sensor according to a second aspect of the disclosure may be configured to include, in the above-described first aspect, a second light collector configured to collect the pulsed light that is incident toward the light-receiving element.

In this case, the second light collector on the light reception side exhibits an effect where the pulsed light that has reflected off the target measurement object and returned therefrom is collected and gathered onto the light-receiving element. As a result, it is possible to prevent various pulsed light from unwanted directions being incident on the light-receiving element, and improve the sensitivity.

A ToF distance sensor according to a third aspect of the disclosure includes a light-emitting element configured to emit pulsed light; a light-receiving element; a cover provided with a first region configured to output the pulsed light emitted from the light-emitting element to an outside, and a second region configured to cause the pulsed light reflected by a target measurement object to be incident toward the light-receiving element; and a second light collector configured to collect the pulsed light that is incident toward the light-receiving element, wherein the second region is configured to be a scattering region that scatters the pulsed light.

In this case, in the second region serving as the scattering region, the pulsed light that reaches the second light collector increases in quantity in comparison with a configuration of passing through a transmissive region, and the incidence of various pulsed light from unwanted directions on the light-receiving element is prevented by the second light collector, thus improving the sensitivity. Due to this, even when a liquid surface of the target measurement object fluctuates, it is possible to accurately and stably detect the transition of the liquid surface.

A ToF distance sensor according to a fourth aspect of the disclosure may be configured to include, in the above-described third aspect, a first light collector configured to collect the pulsed light that is emitted from the light-emitting element and reaches the first region.

In this case, laser light that spreads out from the optical axis of the light-emitting element is converted to parallel light by the first light collector, so that the radiation time variation of light emission is averaged. Due to this, even when the liquid surface of the target measurement object further fluctuates, it is possible to accurately and stably detect the transition of the liquid surface.

A ToF distance sensor according to a fifth aspect of the disclosure may have a configuration in which, in any one of the first to fourth aspects, a separation window is formed between the first region and the second region of the cover.

In this case, the formation of the separation window causes the pulsed light from the light-emitting element to leave through the separation window without being reflected by the cover. With this, crosstalk components can be further decreased.

A ToF distance sensor according to a sixth aspect of the disclosure may have a configuration in which, in any one of the first to fourth aspects, a light blocking region is provided between the first region and the second region of the cover.

In this case, of the pulsed light that is emitted from the light-emitting element and spreads out from the optical axis of the light-emitting element, pulsed light with a directivity angle of 30 degrees or larger, for example, is reflected by the light blocking region. The reflected components are prevented from entering the light reception side configuration by the light blocking region, so that the light is blocked. With this, crosstalk components can be further decreased.

A ToF distance sensor according to a seventh aspect of the disclosure may have a configuration in which, in any one of the first to sixth aspects, the light-emitting element is a vertical cavity surface emitting laser.

In this case, the vertical cavity surface emitting laser emits light orthogonal to a semiconductor substrate, and is able to provide array integration with lower power consumption compared to existing lasers. As the vertical cavity surface emitting laser spreads out from the optical axis, a delay in radiation time occurs, so that the influence of the light beam behavior of the axis component becomes large. Even in this case, the radiation time variation of light emission is averaged, and the distance detection can be performed correctly.

An electronic device according to an eighth aspect of the disclosure provided with a ToF distance sensor may be configured to include, in any one of the first to seventh aspects, the ToF distance sensor according to any one of the first to seventh aspects.

In this case, since the ToF distance sensor is included, it is possible to accurately and stably measure distance.

An electronic device according to a ninth aspect of the disclosure may be configured to detect, in the eighth aspect, a position of a liquid surface with the ToF distance sensor.

In this case, since the liquid surface position is detected with the ToF distance sensor, even when the liquid surface of the target measurement object fluctuates, it is possible to accurately and stably detect the transition of the liquid surface.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A ToF distance sensor comprising:
a light-emitting element configured to emit pulsed light;
a first light collector configured to collect the pulsed light emitted from the light-emitting element;
a light-receiving element; and
a cover provided with a first region configured to output the pulsed light collected by the first light collector to an outside, and a second region configured to cause the pulsed light reflected by a target measurement object to be incident toward the light-receiving element,
wherein the first region is a scattering region configured to scatter the pulsed light.

2. The ToF distance sensor according to claim 1, further comprising:
a second light collector configured to collect the pulsed light that is incident toward the light-receiving element.

3. A ToF distance sensor comprising:
a light-emitting element configured to emit pulsed light;
a light-receiving element;
a cover provided with a first region configured to output the pulsed light emitted from the light-emitting element to an outside, and a second region configured to cause the pulsed light reflected by a target measurement object to be incident toward the light-receiving element; and
a second light collector configured to collect the pulsed light that is incident toward the light-receiving element,
wherein the second region is a scattering region configured to scatter the pulsed light.

4. The ToF distance sensor according to claim 3, further comprising:
a first light collector configured to collect the pulsed light that is emitted from the light-emitting element and reaches the first region.

5. The ToF distance sensor according to claim 1,
wherein a separation window is formed between the first region and the second region of the cover.

6. The ToF distance sensor according to claim 1,
wherein a light blocking region is provided between the first region and the second region of the cover.

7. The ToF distance sensor according to claim 1,
wherein the light-emitting element is a vertical cavity surface emitting laser.

8. An electronic device comprising:
the ToF distance sensor according to claim 1.

9. The electronic device according to claim 8,
wherein the ToF distance sensor detects a position of a liquid surface.
